(19) United States
(12) Patent Application Publication
(10) Pub. No.: US 2007/0097320 A1
(43) Pub. Date: May 3, 2007

(54) Device for projecting images on different projection surfaces

(75) Inventor: Paul Ullmann, Vienna (AT)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA EINDHOVEN (NL)

(21) Appl. No.: 10/559,838

(22) PCT Filed: Jun. 9, 2004
(86) PCT No.: PCT/IB04/50879

§ 371 Date: Dec. 8, 2005

(30) Foreign Application Priority Data
Jun. 12, 2003 (EP) 03 101 712.2

(51) Int. Cl. G03B 21/26

(52) U.S. Cl. 353/30

(57) ABSTRACT

A device (1) for projecting images (2) onto different projection surfaces (3, 4) as desired, having an electro-optical arrangement (34) for generating and emitting light on the basis of image data, and having an optical system (9) that includes a redirecting mechanism (8′) for directing the light, as desired, onto the projection surfaces (3, 4), wherein the optical system (9) has at least one movably mounted optical element (10A, 10B), which optical element (10A, 10B) can be moved into a beam path of the light, or out of the beam path of the light, depending on the projection surface (3, 4) selected for the light to be directed onto.

### DESCRIPTION

The invention relates to a device for projecting images onto different projection surfaces, as desired, having an electro-optical arrangement for generating and emitting light on the basis of image data, and having an optical system that includes a redirecting means for directing the light, as desired, onto the projection surfaces.

A device of this kind for projecting images onto different or varied projection surfaces is known, for example, from patent document U.S. 2002/0105623 A. This device is a projector that directs images, and particularly “moving” symbols, onto various projection surfaces, for which purpose a redirecting device is provided in the form of a mirror able to be pivoted about two axes oriented at right angles to one another. The pivoting movements of the mirror are sensed and fed to electro-optical correcting means to enable the distortion of the projected images to be corrected electronically in line with the inclination of the mirror. However, no allowance is made in this case for the fact that projected images of different sizes are obtained depending on the distance between the projection surface and the video projector, which is often undesirable.

Furthermore, in recent times increasingly frequent use has been made of so-called video projectors for home cinema purposes, where video images are projected onto a wall of a room. There may be a desire in this case for the direction of projection to be changed. In this connection, there is disclosed in patent document U.S. 2003/0002016 A a projector that can be placed in different ways so that its lens is oriented horizontally or vertically as desired. As well as this, a projector of this kind can also be fitted with a pivotable lens to allow images to be projected onto a wall of a room when the lens is in a first position and onto the ceiling of the room when it is in a second position. It is also proposed in this case that the image projector be rotatably arranged on a base to enable rotating images to be projected on the ceiling.

A disadvantage of the known projection devices is that only in a complicated and costly way—if at all—is any action taken on the quality of the images projected onto the different projection surfaces, it also being the case that images of different sizes are obtained, particularly when there are different distances between the projection surfaces and the projection device, which is often a disadvantage and undesirable.

It is therefore an object of the invention to provide a device for projecting images onto different projection surfaces, as desired, in which case image distortion is to be avoided in as simple a way as possible when the images are being projected at different orientations to, and distances from, the projection surfaces, and in particular it is to be possible, at no special cost or complication as far as the equipment is concerned, for images to be projected at their desired sizes even when projected onto projection surfaces situated at various distances.

To allow this object to be achieved, the invention provides a device that can be characterized in the manner specified below, namely:

A device for projecting images onto different projection surfaces, as desired, having an electro-optical arrangement for generating and emitting light on the basis of image data, and having an optical system that includes a redirecting means for directing the light, as desired, onto the projection surfaces, wherein the optical system has at least one movably mounted optical element, which optical element can be moved into a beam path of the light, or out of the beam path of the light, depending on the projection surface selected for the light to be directed onto.

In particular, two such movable optical elements may be provided, namely a redirecting or direction-changing element and an image-forming element.

Thus, in a device according to the invention a movable optical element of the optical system is arranged in the beam path of the light or out of the beam path of the light depending on which projection surface the images are to be projected onto. As a result, the image projection is acted on in such a way that the image that is projected onto the projection surface selected at the time may be of the desired size and quality. If, for example, a redirecting mirror is provided as the redirecting means, it may at the same time form the movably mounted optical element according to the invention, and this redirecting mirror is therefore situated in a first position in the beam path of the light when the light is directed onto a first projection surface and in a second position out of the beam path of the light when the light is directed onto a second projection surface, which means that the light is conveyed to the second projection surface without being redirected. An embodiment of this kind is particularly advantageous when one projection surface is to be a wall of a room and another projection surface is to be the ceiling of the room, in which case, depending on the alignment of the beam path in the projection device, i.e. in its optical system, before the light reaches the redirecting mirror, the redirecting mirror is situated, for example, in the active first position when wall projection is desired, whereas it is situated in the inactive second position when ceiling projection is desired. In the event of the beam path in the optical system of the device being vertically aligned upstream of the redirecting mirror, the said mirror, if it is in the form of a pivoting mirror, may be at, for example, an inclination of approximately 45° to the horizontal in the first position, in order in this way to project the light onto the wall of the room as a first projection surface substantially horizontally and without any distortion. If, however, the redirecting mirror is pivoted out of the—vertical—beam path of the light, the light is conveyed vertically upwards to the ceiling of the room. The redirecting mirror may, with advantage, also be pivotably mounted at an exit opening for the light and may be pivotable to a closed position in which it covers the exit opening. In this case, the exit opening for the light may, in the last-mentioned embodiment giving wall and ceiling projection, be provided in a horizontal upper plane in a housing of the device for projection, and the redirecting mirror thus has a horizontal rest or closed position, a first, active pivoted position at which it is inclined at approximately 45°, and finally a second, inactive pivoted position in which it is pivoted out of the closed position, and thus out of the beam path of the light, by more than 90°.

The repositioning of the redirecting mirror can, basically, be performed manually, in which case adjustable stop means or detent means may be provided to lock it in the two positions, as also may a (pivot) mounting that is relatively stiff, which means that the redirecting mirror remains fixed in its position at the time simply as a result of friction. For greater convenience of operation it is, however, advantageous if the redirecting mirror has associated with it a motor for repositioning it. The motor may in this case be a small and inexpensive electric motor having a reduction gearbox at the output end to produce the to-and-fro movement of the redirecting mirror, through for example a range of pivot of from 0° to 120° or 135°. There may also be provided on the device electronic projection surface selecting means so that setting to “wall projection” or “ceiling projection” can be accomplished virtually “at the press of a button”, in which case the motor can then be connected to the projection surface selecting means to allow it to be controlled.

The situation will often be such that the projection surfaces are at different distances from the projection device, which means that it will be desirable for the image size to be adjusted. In the case of a home cinema for example, it is perfectly conceivable that a distance of from 3 m to 6 m may be available in the case of wall projection, whereas in the case of ceiling projection and if the device is projecting the images from a raised position the projection distance may be a mere 1.5 m or so if room heights are assumed to be from approximately 2.5 m to 3 m. In the present example, what this means is that the area lit by the image on the ceiling will then be only approximately 1/9th of the image area that exists in the case of wall projection. However, in total contrast to this, what would be desirable would be for the ceiling to be lit over a particularly large area. In a particularly advantageous embodiment, the invention therefore makes provision for there to be provided as a movably arranged optical element at least one movable image-forming lens, which is situated in a first position out of the beam path of the light when the light is directed onto a first projection surface and in a second, active position in the beam path of the light when the light is directed onto a second projection surface. In this case, the said at least movable image-forming lens is provided in addition to the above-mentioned redirecting mirror, even though it may also form an embodiment of the movable optical element that is an alternative to the said mirror. Depending on the design of the optical system, the image-forming lens may, for example, be used to make provision for a reduction in the size of the image in the case of wall projection, and is brought into the inactive position in the case of ceiling projection. This, however, would mean that the optical system would have to be designed from the outset for the formation of relatively large images at comparatively short distances of projection, in which case some of this enlargement of the image would have to be cancelled out again for wall projection. It is therefore more advantageous for the image-forming lens to be held in the rest position for wall projection and for it to be moved to the active position in the beam path of the light in the event of ceiling projection, to cause the beam of light to diverge and to enlarge the projected image. It is conceivable in this case for the image-forming lens to be mounted on a pivotable holder and for it to be pivoted to and fro in this way between the rest position and the active position; however, from considerations of space, it is particularly beneficial for the image-forming lens to be mounted on a displaceable slider. Provision may further be made, in this case too, for the image-forming lens to be repositioned manually, but preferably for it to be repositioned by means of a drive motor, in which case the said drive motor may, once again, be connected to the projection surface selecting means to allow it to be controlled. So that only a small amount of space needs to be provided for the image-forming lens, and so that a simple and inexpensive solution can be provided as well, it is useful if the image-forming lens is a Fresnel lens.

If both a redirecting mirror and an image-forming lens are provided as movable optical elements, they may be coupled together for drive purposes. The coupling may even be purely mechanical in this case if the optical elements in question are to be moved manually, in which case the solution adopted may, for example, be one where the redirecting mirror and the image-forming lens are coupled together by a coupling linkage, so that, when the redirecting mirror is repositioned to the second pivoted position out of the beam path of the light, the image-forming lens is, at the same time, displaced into the beam path of the light. The drive coupling may, however, also be provided in an electronic form in a control unit that is coupled to the above-mentioned projection surface selecting means.

The device according to the invention for projecting images onto different projection surfaces can, basically, be constructed in the form of a table-top unit but is preferably constructed as a so-called floor-mounted appliance, i.e. one having a base or feet, for setting up in a room for wall and ceiling projection.

These and other aspects of the invention are apparent from and will be elucidated with reference to the preferred embodiments described hereinafter, though it is not to be considered as limited to these embodiments.

In the drawings:

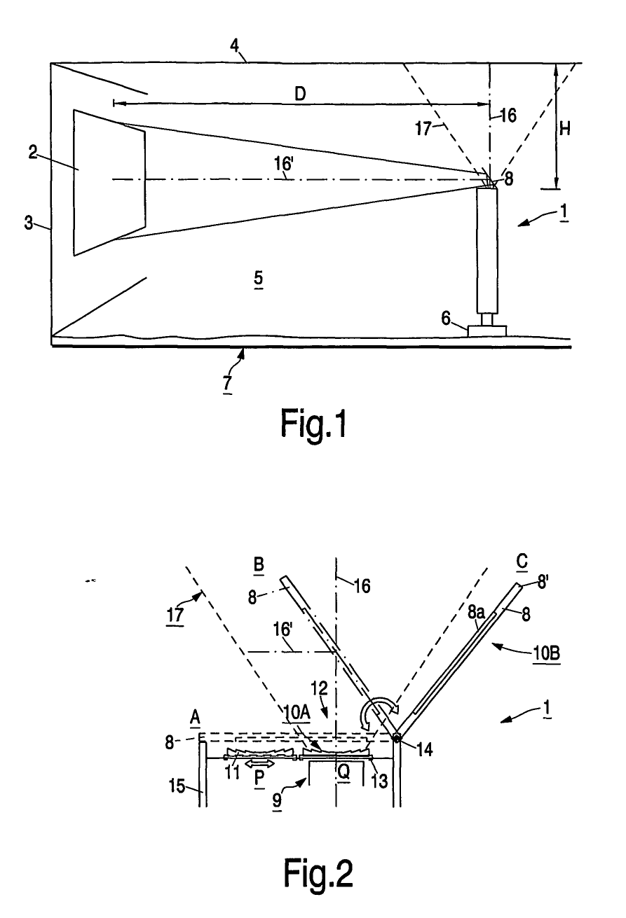

FIG. 1 is a diagrammatic view of a device for projecting images onto a wall of a room or the ceiling of the room, as desired, which device is in the form of a floor-mounted appliance.

FIG. 2 is an entirely diagrammatic vertical cross-section showing the top part of the device for projecting images, and

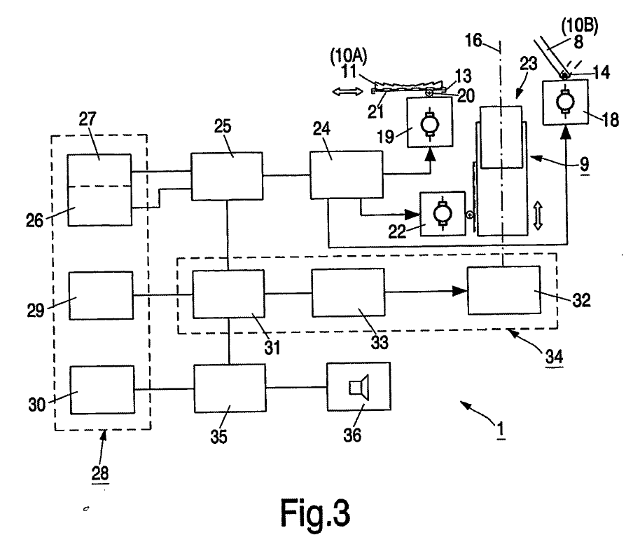

FIG. 3 is a diagrammatic block diagram showing the electronic and optical means of the device.

Shown in FIG. 1 is a device 1 for projecting images 2 alternatively onto a wall 3 of a room 5 that is situated at a distance D or onto the ceiling 4 of the room 5. The device 1 is in the form of a floor-mounted appliance having a base 6, for setting up on the floor 7 of the room 5, as is known per se. Devices of this kind for projecting images, which will be referred to below as projectors for short, are being increasingly used in home cinema systems, in which case the projectors use a wide variety of techniques for generating the beams of light required for the image formation, i.e. projection, such as, say, cathode-ray tubes or DMD panels or LCD panels. Another field of application is projectors for presentation purposes. The image data, and audio data too where appropriate, can be fed to the projectors electronically from a PC that is connected on-line or from reproduction stations such as CD players or DVD players, or directly from an internet connection. The supply of the video and audio data may also be performed wirelessly via an antenna input, in which case the electronic means of the projector then include audio and video input stages having a tuner, as is usual per se. Such items are all sufficiently well known and there is therefore no need for them to be described in detail here.

When in the form of a floor-mounted appliance, the present projector is aligned internally to have a vertical beam path, i.e. a vertical main optical axis 16 (as well as FIG. 1 see also FIG. 2) and is of a suitable height, of the order of 1.5 m to 2 m, say, to ensure that the images 2 can be projected satisfactorily onto the wall 3. The images 2 are projected onto the wall 3 in this case by means of a redirecting means 8′ that forms part of the optical system of the projector 1 and that is in the form of a redirecting mirror 8 having a reflecting area 8a, in which case the redirecting mirror 8 may make an angle of approximately 45° with the horizontal in the active redirecting position shown in FIG. 2. The redirecting mirror 8 is constructed in the form of a pivoting mirror and, in a horizontal position to which, in the view shown in FIG. 1, it is pivoted down in the counterclockwise direction, it rests against the top of the projector 1 as a hinged cover. In the horizontal position, the redirecting mirror 8 protects the components inside the projector 1 from dust etc. In the redirecting position on the other hand, it allows the vertical position of the image 2 on the wall 3 to be exactly set with its reflecting area 8a, in which case a screen such as a cinema screen, etc. may be provided on the wall 3. The said vertical positioning of the image on the wall 3 is thus performed by fine adjustment of the angle of inclination of the redirecting mirror 8, which means that there is no need for height of the projector 1 as a whole to be adjusted. In the event of an adjustment of inclination of this kind being required, it is also known, as mentioned at the beginning, for a keystone correction to be made on the basis of the angle of inclination of the redirecting mirror 8 by means of correcting algorithms.

As well as for conventional wall projection of the above kind, the present projector 1 is also set up for ceiling projection, thus providing an additional possible application for the projector 1. This ceiling projection can be used to project images in a similar way to what happens in the case of wall projection, say to enable a person lying in bed to watch a video film, but it is equally possible for the ceiling projection to be used to reproduce images that are not watched “consciously” or attentively, to project on the ceiling 4 images that tend to be perceived unconsciously such as a sky with clouds or the canopy of leaves formed by trees, etc. Images of this kind are used to divert and relax people and to create a certain ambience.

The direction of projection is different in ceiling projection than in wall projection and the projection of images would be problematic simply in view of image distortion if one and the same redirecting mirror 8 or, in general terms, redirecting means 8′, (see also FIG. 2) were used for both directions of projection. It may be mentioned that the main optical axis 16 may be arranged to lie in a horizontal direction.

The problem arises with ceiling projection as compared with wall projection that, if other steps were not taken, a considerably smaller image would be produced in the case of ceiling projection, as compared with the size of the image in the case of wall projection, due to the considerably shorter distance H to the ceiling than D to the wall (see FIG. 1). The ratio between these two distances H and D may be of the order of 1:3, which also means that corresponding requirements have to be met by the focusing or adjustment of sharpness of the optical system 9 of the projector 1.

To solve these problems, special movable optical elements 10A, 10B have therefore been provided in the present projector 1 in the region of the optical system 9 of the projector 1, which optical system 9 is only shown diagrammatically in FIG. 2. One movable optical element 10B is formed in this case by the redirecting means 8′, i.e. the redirecting mirror 8, which can be pivoted from its active first pivoted position B, which is shown in dotted and dashed lines in FIG. 2 and which the redirecting mirror 8 occupies in the case of wall projection (see FIG. 1), to an inactive second position C that is shown in FIG. 2 in solid lines.

Provided as a second movable optical element 10A, preferably in combination with the first movable optical element 10B, namely the redirecting means 8′, at the top of optical system 9 of the projector 1 in the region of the latter's exit opening 12 for the light, is an image-forming lens 11. The said image-forming lens 11 is mounted on a slider 13 that is only shown schematically and that is movable linearly on lateral guides that are not visible in any detail. In this way, the image-forming lens 11 can be repositioned between the first, inactive position P that is shown in dashed lines in FIG. 2 and is occupied during wall projection, and a second, active position Q for ceiling projection that is shown in solid lines.

Also shown schematically in FIG. 2 is a pivot mounting 14 for the redirecting mirror 8 that is provided on the housing 15 of the projector 1, laterally of the exit opening 12 for the light, and something else that is shown, as well as this, is, in dashed lines, the horizontal closed position A of the redirecting mirror 8 on the top of the housing 15, i.e. the position in which the redirecting mirror 8 closes off the exit opening 12 for the light. Shown in addition is the vertical optical axis 16 of the optical system 9 of the projector 1, which system 9 is vertically aligned in operation, the centerline 16′ of the beam pointing, after redirection or change of direction at the redirecting mirror 8 in the approximately horizontal direction of projection used for wall projection, at which time the redirecting mirror 8 is in the active first pivoted position B (see the position shown in dotted and dashed lines in FIG. 2). What is also shown, as a widely diverging cone of light 17, is the state of the beam of light in ceiling projection, this comparatively wide divergence of the beam of light being achieved by means of the image-forming lens 11, which is moved to its position Q in the beam path for this case of ceiling projection, whereas the redirecting mirror 8 is pivoted out of the beam path to its inactive second pivoted position C, as shown in FIG. 2 in solid lines.

The image-forming lens 11 is preferably formed by a Fresnel lens, by which the range of focus is adapted, i.e. the adjustment of focus that would otherwise be necessary is reduced, and which also effects an at least partial correction of the image projected onto the ceiling. It should also be borne in mind that, in contrast to what applies in the case of wall projection, the image quality required in ceiling projection is, as a rule, not particularly high when the images in the ceiling projection are, as mentioned above, ones that tend to be “unconsciously” or subconsciously perceived, so that even the image-forming quality of a simple Fresnel lens is good enough. A Fresnel lens of this kind as the image-forming lens 11 also has the advantage that it is particularly economical of space. It is of course also possible for other (concave) lens (or lens systems having a plurality of lens) that cause the beam of light to diverge to be used as movable optical elements 10A rather than a Fresnel lens. It is moreover conceivable for the image-forming lens 11 to be divided, e.g. into two part-lenses that are adjustable relative to one another. This adjustment may take place in the same direction, but it has proved to be highly advantageous if the two part-lenses can be moved into and out of the beam path of the light by being moved in opposite directions. Preferably, the part-lenses can be moved towards or away from one another in opposite directions, in order in this way for less space to be required for the sliding movements in the horizontal direction. It is also conceivable for provision to be made for the image-forming lens 11 not to perform a linear movement but a pivoting movement in the horizontal plane or even a hinging movement about a horizontal axis, in a similar way to the redirecting mirror 8. In principle, the image-forming lens 11 may even be omitted if, when the differences between the distances H and D are not too large and the requirements to be met by the image-forming quality with the redirecting mirror 8 pivoted to the inactive position are fairly low, it is possible to manage with the said redirecting mirror 8 as the sole movable optical element 10B. This may perfectly well be the case if all that is desired apart from the image projection that is wanted for the viewing of video films is specially varying ambient lighting in the room produced by modulated colored light with no particular image content, in which case only the brightness and color for example of this ambient lighting will be modulated.

The redirecting mirror 8 can, basically, be pivoted manually, in which case it is conceivable for the pivot mounting 14 to be arranged to be relatively stiff, so that the redirecting mirror 8 remains fixed by frictional engagement in any position to which it is set. In a similar way, the other movable optical element 10A, namely the image-forming lens 11, can be moved to the active position Q, and from this position back to the inactive position, manually. In particular, it is conceivable in this case for a driving connection to be provided between the two optical elements 10A, 10B, say by means of a traction cable and/or a linkage (not shown).

Preferably however, a motor drive is provided for each of the two movable optical elements 10A, 10B, in the form say of an electric motor 18 (see also FIG. 3), having an associated output gearbox, that is associated with the redirecting mirror 8 at the pivot mounting 14, and in the form of a further electric drive motor 19 for the image-forming lens 11, this drive motor 19 driving, for example, a pinion 20 that meshes with a rack 21 on the slider 13 on which the image-forming lens 11 is arranged.

As shown in FIG. 3, a farther motor 22 may be provided for the automatic focusing of an objective lens 23 of the optical system 9. As shown in FIG. 3, all the motors 18, 19, 22 are driven by a motor driver circuit 24 whose input is connected to a motor control circuit 25 that produces a coupling of the drives for the optical elements 10A, 10B in electronic form to enable them to be moved sequentially or simultaneously. Associated with the motor control circuit 25 at the latter's input end is an input module 26 for manual operation, this input module 26 comprising electronic projection surface selecting means 27 to enable the redirecting mirror 8 and the image-formed lens 11 to be controlled automatically to the appropriate position in this way when either wall projection or ceiling projection is selected, with the help of the motor control circuit 25 and the motor driver circuit 24 and the corresponding motors 18, 19.

The input module 26, which is part of an input unit 28 indicated in dashed lines, may in addition be provided with other inputs such as, say, for manual focusing of the objective lens 23.

The input unit 28 also includes a video input module 29 and an audio input module 30. Connected downstream of the video input module 29 is a digital signal processor circuit (video DSP) 31 to enable appropriate image data for the control of a light source 32 via a driver circuit 33 to be obtained from the incoming digital or analog video input signal. As mentioned, the light source 32 may, for example, be implemented in the form of an LCD panel. This being the case, electro-optical means 34 for image generation are formed by these components.

In a similar way, an audio signal processor unit (audio DSP) 35, which drives loudspeakers 36 via a multi-channel output, is connected to the audio input module 30.

The input unit 28 may also have associated with it a remote control (not shown) for the projection surface selecting means 27 and thus for the motors 18, 19, 22 and, as mentioned, conventional antenna inputs with input stages etc. may act as input modules 29, 30 for the video signal and audio signal respectively.

The video and audio signals may also be analyzed in the digital signal processors 31, 35 in such a way that, in cases where a background “image” (“ambient lighting”) is to be produced and as dictated by the programming, lighting effects can be produced from them in preprogrammed sequences, in which case matching patterns of light of suitable colors and intensities and in suitable sequences can, if required, be generated directly from analyses of the audio and video signals. In this way, where the audio signal is dance music for example, lightning-like lighting effects in different colors can be produced automatically on the ceiling 4 of the room 5 to encourage a party mood.

It may be mentioned that a device according to the invention in the form of an embodiment modified from the device 1 that has been described above may also be arranged to project images onto two different walls of a room, both of which preferably extend perpendicularly or at a slight inclination, or even onto more than two different projection surfaces, such as, say, onto three or four projection surfaces.

1. A device (1) for projecting images (2) onto different projection surfaces (3, 4), as desired, having an electro-optical arrangement (34) for generating and emitting light on the basis of image data, and having an optical system (9) that includes a redirecting means (8′) for directing the light, as desired, onto the projection surfaces (3, 4), wherein the optical system (9) has at least one movably mounted optical element (10A, 10B), which optical element (10A, 10B) can be moved into a beam path of the light, or out of the beam path of the light, depending on the projection surface (3, 4) selected for the light to be directed onto.

2. A device (1) as claimed in claim 1, wherein at least one redirecting mirror (8) is provided as the redirecting means (8′), which redirecting mirror at the same time forms the movably mounted optical element (10B) and which redirecting mirror is situated in a first position (B) in the beam path of the light when the light is directed onto a first projection surface (3) and which redirecting mirror is situated in a second position (C) out of the beam path of the light when the light is directed onto a second projection surface (4).

3. A device (1) as claimed in claim 2, wherein the redirecting mirror (8) is pivotably mounted in front of an exit opening (12) for the light and can be pivoted to a closed position (A) in which it covers the exit opening (12).

4. A device (1) as claimed in claim 2, wherein the redirecting mirror (8) has associated with it a motor (18) for repositioning the redirecting mirror.

5. A device (1) as claimed in claim 4, wherein the motor (18) is connected to electronic projection surface selecting means (27) to enable it to be controlled.

6. A device (1) as claimed in claim 1, wherein at least one movable image-forming lens (11) is provided as the movably arranged optical element (10A), which image-forming lens (11) is situated in a first position (P) out of the beam path of the light when the light is directed onto a first projection surface (3) and which image-forming lens (11) is situated in a second, active position (Q) in the beam path of the light when the light is directed onto a second projection surface (4).

7. A device (1) as claimed in claim 6, wherein the image-forming lens (11) comprises at least two part-lenses.

8. A device (1) as claimed in claim 6, wherein the image-forming lens (11) is mounted on a displaceable slider (13).

9. A device (1) as claimed in claim 6, wherein the image-forming lens (11) has associated with it a drive motor (19) for repositioning said image-forming lens (11).

10. A device (1) as claimed in claim 9, wherein the motor (19) is connected to electronic projection surface selecting means (27) to enable it to be controlled.

11. A device (1) as claimed in claim 6, wherein the image-forming lens (11) is formed by a diverging lens to cause the beam of light to diverge for projection of the images onto a projection surface (4) provided at a comparatively short distance.

12. A device (1) as claimed in claim 11, wherein the image-forming lens (11) is formed by a Fresnel lens.

13. A device (1) as claimed in claim 2, wherein at least one movable image-forming lens (11) is provided as a further movably mounted optical element (10A), which image-forming lens (11) is situated in a first position (P) out of the beam path of the light when the light is directed onto the first projection surface (3) and which image-forming lens (11) is situated in a second, active position (Q) in the beam path of the light when the light is directed onto the second projection surface (4).

14. A device (1) as claimed in claim 13, wherein the redirecting mirror (8) and the image-forming lens (11) are coupled together for drive purposes.

15. A device (1) as claimed in claim 1, wherein the device (1) is in the form of a floor-mounted appliance for setting up in a room (5) for wall projection and ceiling projection.
